(19) United States
(12) Patent Application Publication
(10) Pub. No.: US 2024/0332835 A1
(43) Pub. Date: Oct. 3, 2024

(54) TERMINAL BLOCK ASSEMBLY AND TERMINAL BLOCK ASSEMBLY STRUCTURE

(71) Applicant: Yazaki Corporation, Tokyo (JP)

(72) Inventors: Hiroaki ONO, Makinohara-shi (JP); Toru SUZUKI, Makinohara-shi (JP); Daisuke YAMANASHI, Makinohara-shi (JP)

(73) Assignee: Yazaki Corporation Tokyo, Tokyo (JP)

(21) Appl. No.: 18/593,480

(22) Filed: Mar. 1, 2024

(30) Foreign Application Priority Data
Mar. 27, 2023 (JP) 2023-049257

(51) Int. Cl. H01R 9/26; H01R 9/18; H01R 9/20; H01R 9/24; H01R 101/00

(52) U.S. Cl. CPC H01R 9/2608; H01R 9/18; H01R 9/20; H01R 9/2616; H01R 9/2416; H01R 2101/00; H01R 2201/26

(57) ABSTRACT

A terminal block assembly, includes a unipolar terminal block in which a terminal is held by a resin portion, a first connection portion being formed at one end side of the terminal and a second connection portion being formed at the other end side of the terminal; and a plate on which a plurality of holding holes for holding the unipolar terminal block are formed, wherein the unipolar terminal block is held by the holding holes in a state in which the first connection portion is positioned at one side of the plate and the second connection portion is positioned at the other side of the plate, and the unipolar terminal block is held by each holding hole of the plate.

### TECHNICAL FIELD

The present invention relates to a terminal block.

### BACKGROUND ART

There are various structures included in terminal blocks for wiring connections, and an example thereof is shown in FIG. 7 (see Patent Document 1). A terminal block 500 shown in FIG. 7 is fixed to a housing of a travel motor mounted on a vehicle, and includes three busbars 502, two collars 503, and a housing 504 holding these configurations.

Each busbar 502 includes a first connection portion 521 and a second connection portion 522. The first connection portion 521, for example, is connected to a terminal of a motor for travelling. The second connection portion 522, for example, is connected to a terminal of an inverter.

The collar 503 is made of metal and has a cylindrical shape. A bolt for fixing the terminal block 500 to a housing of the motor for travelling is passed through the collar 503.

The housing 504 is made of insulating synthetic resin. The housing 504 is formed by filling a mold cavity with molten resin and solidifying the molten resin. Also, the busbar 502 and the collar 503 are set in the mold cavity when the housing 504 is molded, and are insert-molded into the housing 504.

In addition to the terminal block 500 described above, there are terminal blocks of various shapes to match the mounting conditions of each vehicle.

### CITATION LIST

### Patent Documents

[Patent Document 1] JP 2022-52013A

### SUMMARY OF THE INVENTION

### Technical Problem

With regard to manufacturing the terminal blocks of various shapes described above, it is necessary to construct a mold for each product, which leads to a problem of increasing development time and cost.

Therefore, an object of the present invention is to provide a terminal block assembly that does not require a dedicated mold, and a terminal block assembly structure using this terminal block assembly.

### Solution to Problem

A terminal block assembly according to the present invention includes a unipolar terminal block in which a terminal is held by a resin portion, a first connection portion being formed at one end side of the terminal and a second connection portion being formed at the other end side of the terminal; and a plate on which a plurality of holding holes for holding the unipolar terminal block are formed, wherein the unipolar terminal block is held by the holding holes in a state in which the first connection portion is positioned at one side of the plate and the second connection portion is positioned at the other side of the plate, and the unipolar terminal block is held by each holding hole of the plate.

A terminal block assembly structure according to the present invention includes the above-described terminal block assembly, and a plate-shaped attached portion to which the terminal block assembly is attached, wherein a plurality of insertion holes through which the unipolar terminal block is inserted are formed in the attached portion, and the unipolar terminal block is immovable in the state in which the unipolar terminal block is inserted through the insertion holes.

### Effect of the Invention

According to the present invention, it is possible to provide a terminal block assembly that does not require a dedicated mold, and a terminal block assembly structure using the terminal block assembly.

### BRIEF DESCRIPTION OF THE DRAWINGS

FIG. 1 is a perspective view showing a terminal block assembly according to a first embodiment of the present invention.

FIG. 2 is an exploded view showing the terminal block assembly in FIG. 1.

FIG. 3 is a cross-sectional view along a line A-A in FIG. 2.

FIG. 4 is a cross-sectional view showing a terminal block assembly structure in which the terminal block assembly in FIG. 1 is attached to an attached portion.

FIG. 5 is a perspective view showing a terminal block assembly according to a second embodiment of the present invention.

FIG. 6 is a perspective view showing a terminal block assembly according to a third embodiment of the present invention.

FIG. 7 is a perspective view showing a conventional block terminal.

### DESCRIPTION OF EMBODIMENTS

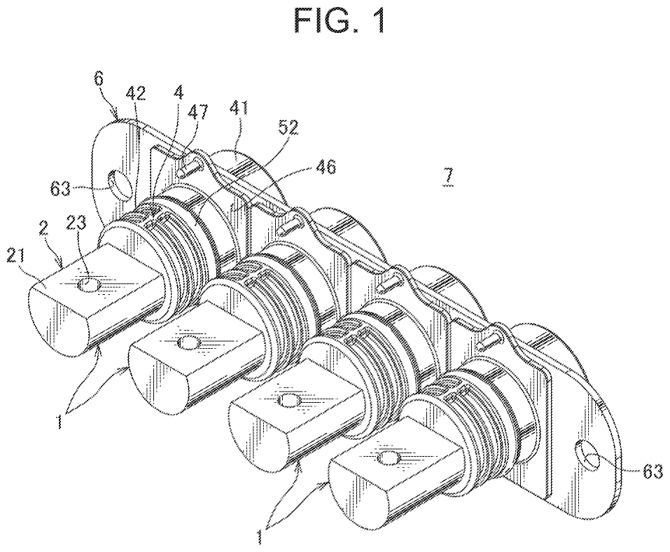

A “terminal block assembly” and a “terminal block assembly structure” according to a first embodiment of the present invention will be described with reference to FIG. 1 to FIG. 4.

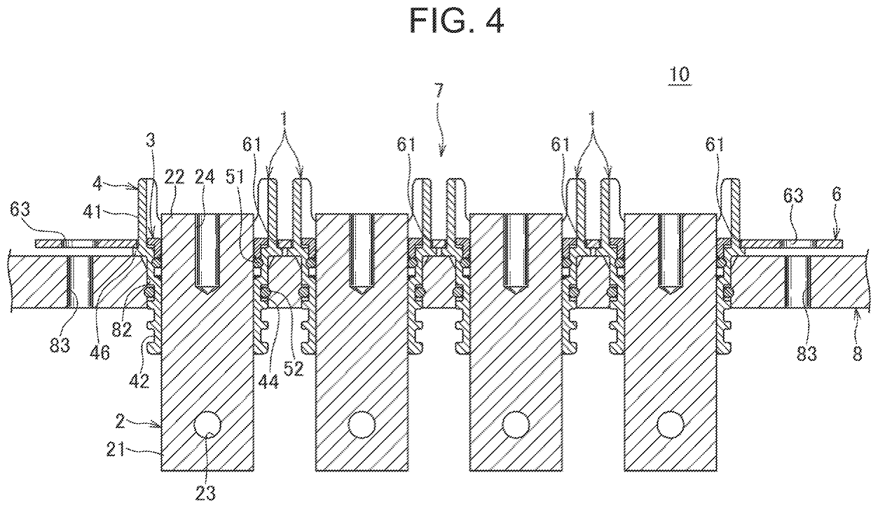

The terminal block assembly 7 shown in FIG. 1 is used for connecting wires to each other. The terminal block assembly 7 is attached to, for example, a case 8 (corresponding to a “plate-shaped attached portion”) shown in FIG. 4, and forms a terminal block assembly structure 10 together with the case 8.

The terminal block assembly 7 includes four unipolar terminal blocks 1 and a plate 6 in which four circular holding holes 61 for holding the unipolar terminal blocks 1 are formed, wherein the terminal block assembly 7 is configured that each unipolar terminal block 1 is held by each holding hole 61.

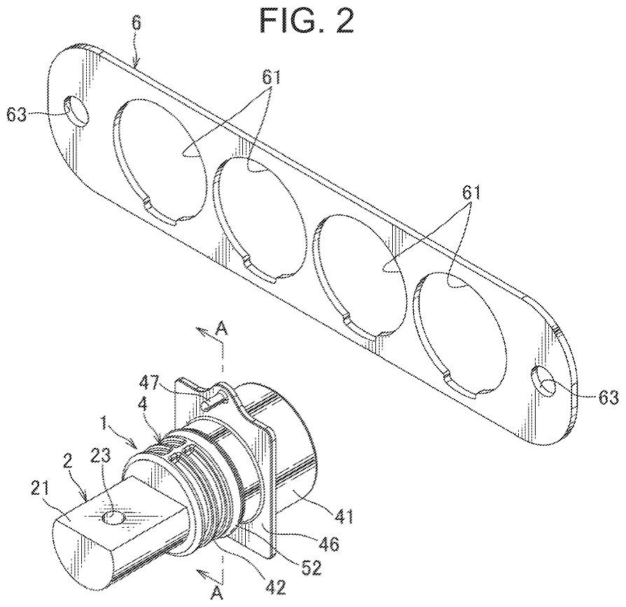

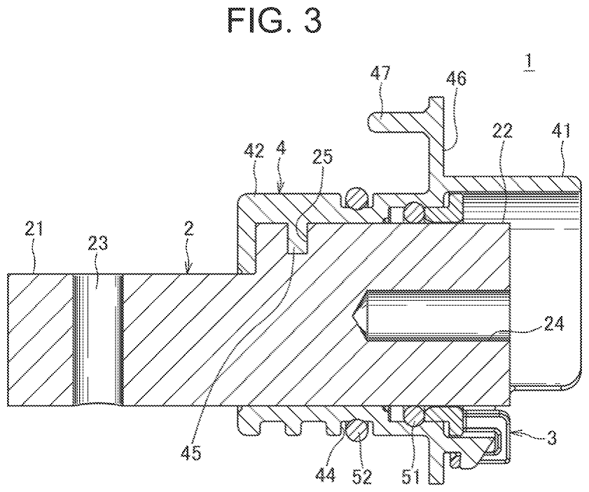

All of the four unipolar terminal blocks 1 have the same configuration. As shown in FIG. 2 and FIG. 3, each unipolar terminal block 1 includes a unipolar terminal 2 in which a first connection portion 21 is formed on one end side and a second connection portion 22 on the other end side, a resin portion 4 holding this terminal 2, annular packings 51, 52, and a holder 3.

The first connection portion 21 is formed into a partial cylindrical shape by dividing a cylinder along a plane parallel to a central axis thereof, and includes a bolt insertion hole 23.

The second connection portion 22 is formed in a cylindrical shape and includes a female threaded portion 24. The female threaded portion 24 is configured of a hole formed concavely from the other end of the terminal 2, and a screw cut spirally on an inner circumferential surface of this hole.

A groove 25 filled with a retaining portion 45 of the resin portion 4 is formed in the central portion of the terminal 2.

The resin portion 4 is made of an insulating synthetic resin and includes a terminal holding portion 42, a flange portion 46, a surrounding wall 41, a pin 47, and the retaining portion 45.

The terminal holding portion 42 is formed in a cylindrical shape and covers the outer circumferential surface of the central portion of the terminal 2. The retaining portion 45 protrudes from the inner surface of the terminal holding portion 42 and is filled within the groove 25 of the terminal 2. A packing attachment groove 44 to which the annular packing 52 is attached is formed on the outer circumferential surface of the terminal holding portion 42.

The flange portion 46 extends outward from the outer circumferential surface of the terminal holding portion 42. The surrounding wall 41 extends in a cylindrical shape from the flange portion 46 to the side opposite to the terminal holding portion 42. The surrounding wall 41 surrounds the second connection portion 22 of the terminal 2. The pin 47 protrudes from the flange portion 46 on the side opposite to the surrounding wall 41.

The packing 51 is attached to the outer circumferential surface of the second connection portion 22 of the terminal 2, and seals a gap between the outer circumferential surface of the second connection portion 22 and the inner circumferential surface of the terminal holding portion 42. The holder 3 is a member for preventing the packing 51 from falling off the outer circumferential surface of the second connection portion 22, and is retained to the surrounding wall 41.

As shown in FIG. 2, the plate 6 is formed into an elongated plate shape, and has four holding holes 61 formed in its longitudinal direction. The bolt insertion holes 63 are formed at both end portions of the plate 6 in the longitudinal direction. Although the plate 6 in this example is made of metal in order to ensure the strength, it may be made of the resin as long as the strength can be ensured.

Regarding the above-described unipolar terminal block 1, the unipolar terminal block 1 is held by the holding hole 61 in a state in which the surrounding wall 41 is passed through the holding hole 61, the flange portion 46 is stacked on the plate 6, the first connection portion 21 is positioned on one side of the plate 6, and the second connection portion 22 is positioned on the other side of the plate 6.

Further, the holding hole 61 is formed larger than the outer diameter of the surrounding wall 41 such that the unipolar terminal block 1 is movable in a surface direction of the plate 6 while the unipolar terminal block 1 is held in the holding hole 61. The reason for configuring such dimensions is to enable the alignment of the terminal 2 with respect to the wiring component to which the terminal 2 is electrically connected.

Since such a terminal block assembly 7 is configured by holding four unconnected unipolar terminal blocks 1 with the plate 6, a dedicated mold is not required. Further, by preparing a plurality of types of plates 6, it is possible to flexibly respond to changes in the pitch between the terminals 2, changes in the number of poles of the terminals 2, and the like. In this manner, the unipolar terminal block 1 can correspond to various specifications.

The terminal block assembly structure 10 shown in FIG. 4 includes the above-described terminal block assembly 7 and a case 8 of an inverter mounted on the vehicle. The case 8 has four insertion holes 82 through which the terminal holding portions 42 of the unipolar terminal block 1 are inserted, two bolt insertion holes 83 through which the bolts passed through the bolt insertion holes 63 of the plate 6 are inserted, and four holes into which the pins 47 of the unipolar terminal block 1 are inserted, formed therein.

The terminal block assembly 7 is brought close to the case 8, the terminal holding portion 42 of each unipolar terminal block 1 is inserted into each insertion hole 82, the bolts are inserted into each bolt insertion hole 63 and each bolt insertion hole 83, and the nuts are screwed into the bolts such that the terminal block assembly 7 is fixed to the case 8. Further, the gap between the insertion hole 82 and the terminal holding portion 42 is sealed by the packing 52 attached to the packing attachment groove 44 of each unipolar terminal block 1.

Furthermore, in the state before the terminal block assembly 7 is fixed to the case 8, the unipolar terminal block 1 is held in the holding hole 61 so as to be movable in the surface direction of the plate 6. However; in the state in which the unipolar terminal block 1 is inserted through the insertion hole 82, the unipolar terminal block 1 becomes immovable. In this manner, the unipolar terminal block 1 is inserted into the insertion hole 82 of the case 8, and thereby aligned for each pole.

In the state in which the terminal block assembly 7 is fixed to the case 8, the first connection portion 21 of each unipolar terminal block 1 is positioned on one side of the case 8, that is, on the inner side of the case 8. These first connection portions 21 are overlapped by the terminals of the inverter, and then fastened together by the bolts inserted through the bolt insertion holes 23 and the nuts screwed to these bolts. As described above, since the unipolar terminal block 1 is aligned for each pole, it can be overlapped with the terminals of the inverter with the high positional accuracy. Further, in the state in which the terminal block assembly 7 is fixed to the case 8, the second connection portion 22 of each unipolar terminal block 1 is positioned on the other side of the case 8, that is, at the outer side of the case 8. These second connection portions 22 are overlapped with the round terminals connected to the ends of the electric wires, and then are fastened together with the round terminals by the bolts screwed into the female screw portions 24.

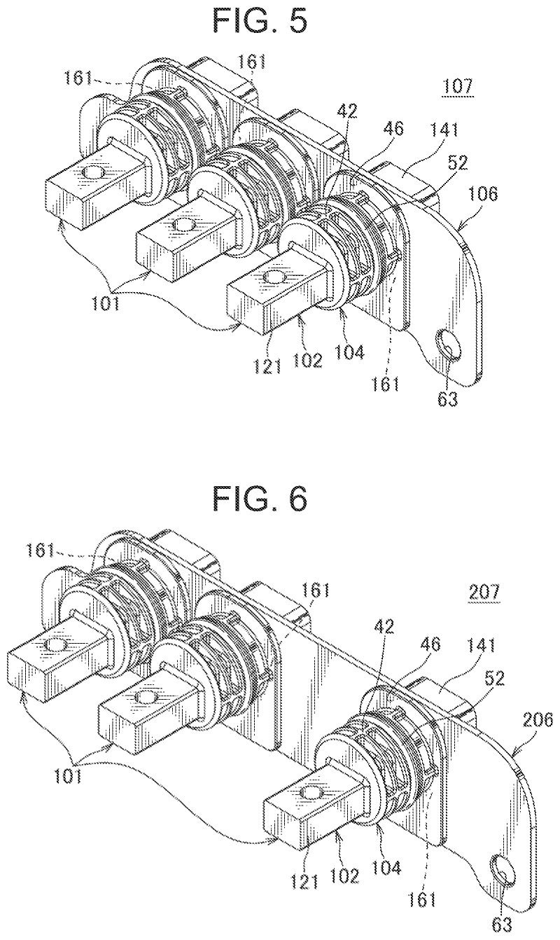

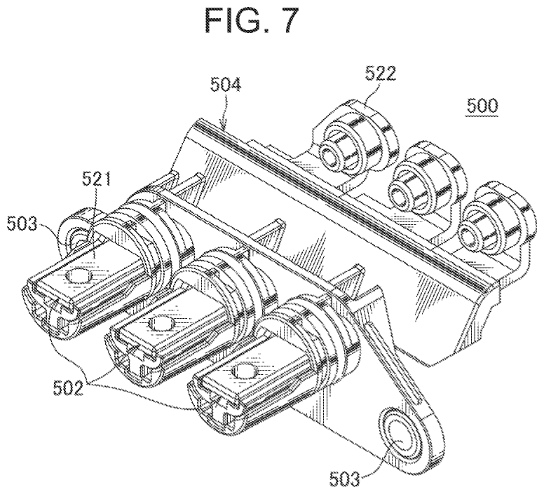

A “terminal block assembly” according to a second embodiment of the present invention will be described with reference to FIG. 5. In FIG. 5, the same components as those in the first embodiment are assigned by the same reference signs, and the description thereof will be omitted.

The terminal block assembly 7 according to the first embodiment has the configuration including four unipolar terminal blocks 1 and the plate 6, however, a terminal block assembly 107 according to this example includes three unipolar terminal blocks 101, and the plate 106.

The terminal 102 of the unipolar terminal block 101 is configured with a prismatic first connection portion 121 formed therein. Further, the resin portion 104 of the unipolar terminal block 101 includes a rectangular cylindrical surrounding wall 141.

Three holding holes 161 are formed in the plate 106. The holding hole 161 is formed in a rectangular shape since the rectangular tubular surrounding wall 141 is passed therethrough.

Similar to the terminal block assembly 7 according to the first embodiment, the terminal block assembly 107 according to this example also does not require the dedicated mold.

A “terminal block assembly” according to a third embodiment of the present invention will be described with reference to FIG. 6. In FIG. 6, the same components as those in the first and second embodiments are assigned by the same reference signs, and the description thereof will be omitted.

A terminal block assembly 207 according to this example is configured to include three unipolar terminal blocks 101 and the plate 206. In the terminal block assembly 107 according to the second embodiment, the pitch between the terminals 102 of the three unipolar terminal blocks 101 was equal to each other, however, in the terminal block assembly 207 according to this example, the pitch between the terminals 102 of the three unipolar terminal blocks 101 is unequal.

Similar to the terminal block assembly 107 according to the second embodiment, the terminal block assembly 207 according to this example also does not require the dedicated mold. That is, by changing the plate 106 according to the second embodiment to the present plate 206, it is possible to correspond to the changes in the pitch between the terminals 102.

Also, the above-described embodiment merely shows a typical embodiment of the present invention, and the present invention is not limited to this embodiment. That is, various modifications can be made without departing from the spirit of the present invention. Once the configurations according to the present embodiment are included, even if such modifications are applied, the configurations should be included within the scope of the present invention.

### REFERENCE SIGNS LIST

1, 101 unipolar terminal block
2, 102 terminal
4, 104 resin portion
6, 106, 206 plate
7, 107, 207 terminal block assembly
8 case (mounted portion)
10 terminal block assembly structure

What is claimed is:

1. A terminal block assembly, comprising:
a unipolar terminal block in which a terminal is held by a resin portion, a first connection portion being formed at one end side of the terminal and a second connection portion being formed at the other end side of the terminal; and
a plate on which a plurality of holding holes for holding the unipolar terminal block are formed,
wherein the unipolar terminal block is held by the holding holes in a state in which the first connection portion is positioned at one side of the plate and the second connection portion is positioned at the other side of the plate, and
the unipolar terminal block is held by each holding hole of the plate.

2. The terminal block assembly according to claim 1, wherein the holding holes are formed to be larger than the unipolar terminal block such that the unipolar terminal block is movable in a surface direction of the plate in the state in which the unipolar terminal block is held by the holding holes.

3. A terminal block assembly structure, comprising:
the terminal block assembly according to claim 2, and
a plate-shaped attached portion to which the terminal block assembly is attached,
wherein a plurality of insertion holes through which the unipolar terminal block is inserted are formed in the attached portion, and
the unipolar terminal block is immovable in the state in which the unipolar terminal block is inserted through the insertion holes.
